(19) United States
(12) Patent Application Publication
(10) Pub. No.: US 2020/0043034 A1
(43) Pub. Date: Feb. 6, 2020

(54) METHOD FOR DISCOUNTING A TARIFF THROUGH PARTICIPATION IN AN INTERACTIVE WAGERING SYSTEM

(71) Applicant: Zachary Louis ARENSON, Tarzana, CA (US)

(72) Inventor: Zachary Louis ARENSON, Tarzana, CA (US)

(21) Appl. No.: 16/531,851

(22) Filed: Aug. 5, 2019

Related U.S. Application Data
(60) Provisional application No. 62/714,292, filed on Aug. 3, 2018.
(60) Provisional application No. 62/747,760, filed on Oct. 19, 2018.

(51) Int. Cl. G06Q 30/02; G06Q 50/34

(52) U.S. Cl. CPC G06Q 30/0222; G06Q 50/34; G06Q 30/0215

(57) ABSTRACT

Disclosed herein are systems and methods that allow a customer of a retail establishment to secure a discount for goods and/or services they are currently purchasing or may purchase in the future based on successful participation with an interactive wagering tool.

### CROSS-REFERENCE TO RELATED APPLICATIONS

The present application claims the benefit of priority under 35 U.S.C. § 119(e) of prior U.S. Provisional Application Ser. No. 62/714,292, filed Aug. 3, 2018, and U.S. Provisional Application Ser. No. 62/747,760, filed Oct. 19, 2019, the entire contents of which are incorporated herein.

### TECHNICAL FIELD

This invention pertains generally to methods for providing discount coupons for goods or services, and/or for discounting the tariff of a paying customer at a retail establishment, and also pertains to a software application that provides an interactive tool allowing consumers to secure the discount(s) by placing wagers on sporting events.

### BACKGROUND

The bar industry in the United States is a 25 billion dollar industry; a figure that rises to 783 billion dollars if the overall restaurant industry is included. These public venues are always searching for new ways to attract and retain customers. In the past, some venues have offered onsite gaming for this purpose. For example, electronic trivia has been offered for many years, allowing onsite patrons to answer trivia questions using a wireless device, often provided to them by the venue. Players typically play alone or in teams against other players in the venue, or against individuals and/or teams playing in other venues. Providing enjoyable onsite gaming increases the time spent by patrons at such venues, resulting in higher sales and profits.

Rewards programs have also been used in the past to try to retain customer loyalty and drive sales. Such programs typically award a patron credits or coupons when they purchase certain goods and services. These credits or coupons may be used for future purchases. The expectation of the retail establishment is that the credits or coupons may elicit impulse buys when the consumer returns to the establishment.

Sports betting, or predicting the outcome of a sporting event, is a popular activity in the United States, supporting an estimated 400 billion dollar industry. Many venues in the restaurant and bar industries provide live stream of one or more sporting events. Moreover, interactive sports betting games are becoming increasingly popular with the advent of cellular phones and tablets that include wireless technologies. None, however, provide features that allow a user to improve their odds based on the user's actions. Additionally, none allow the consumers to secure a discount for goods and/or services they are purchasing or may purchase in the future by placing a successful wager on a sporting event.

Accordingly, it would be desirable to provide a rewards program based on sports-based entertainment and wagering that allows a user to influence the reward outcome. It would also be desirable to provide a software application that implements the rewards program and provides the user with an interactive wagering tool accessible on an electronic device.

### SUMMARY

The presently disclosed invention is related to methods and systems that allow consumers to secure a discount for goods and/or services they are purchasing or may purchase in the future by placing wagers on sporting events. According to certain aspects, the method provides a wagering tool that awards a discount to a user based on a combination of the accuracy of the user's predictions of outcomes of an event, such as a sporting event, and user defined outcomes such as the monetary amount of a retail purchase, length and volume of participation with a venue at which the method is presented (e.g., restaurant or bar, hotel, retail store), and other factors. Thus, the user, having knowledge of the factors on which the award of discount is based, may be able to manipulate the amount of the discount. The discounts may be provided as a reduced tariff for a current service, or as a coupon that may provide a discount on a future purchase of goods and/or services. The sporting event may be a real-time event or one scheduled in the future, and wagers may be placed any-time before the start of the event or during the event.

Accordingly the present invention provides a method for discounting a tariff at a retail establishment that generally includes: presenting a plurality of targets on an output interface of a network enabled device, wherein each of the plurality of targets is related to a consumer opportunity; receiving from an input interface of the network enabled device a selection of one of the plurality of targets; presenting a plurality of betting zones on the output interface of the network enabled device, wherein each of the plurality of betting zones is related to a predefined occurrence; receiving from the input interface of the network enabled device a wager, wherein the wager comprises a selection of at least one of the plurality of betting zones; calculating a predicted discount amount useable at the target based on a favorable outcome of the at least one betting zone; and presenting the predicted discount amount on the output interface of the network enabled device.

According to certain aspects, the method may further comprise associating the wager with a user account. Further, the method may comprise associating a successful outcome for the wager with a coupon for the predicted discount amount usable at the selected target, wherein the coupon is associated with a user account, and presenting the coupon on the output interface of the network enabled device.

According to certain aspects, the method may further comprise receiving a scan of at least one retail receipt and associating the scanned receipt with a user account, wherein each scanned receipt is assigned one token. Further, the method may comprise determining if the user account has at least one token associated therewith, and if the user account does have at least one token, associate a successful outcome for the wager with a coupon for the predicted discount amount usable at the selected target or allow use of the coupon garnered from the successful outcome for the wager.

The present invention further provides a wagering system comprising a non-transitory memory comprising processor-executable instructions, and a processor coupled to the non-transitory memory and configured to execute the processor-executable instructions, wherein the processor-executable instructions provide the methods disclosed herein.

The present invention further provides one or more tangible machine-readable storage media having instructions stored thereon, which when executed by a set of one or more processors causes the set of one or more processors to perform operations of the methods disclosed herein.

### BRIEF DESCRIPTION OF THE DRAWINGS

Aspects, features, benefits and advantages of the embodiments herein will be apparent with regard to the following description, appended claims, and accompanying drawings. In the following figures, like numerals represent like features in the various views. It is to be noted that features and components in these drawings, illustrating the views of embodiments of the present invention, unless stated to be otherwise, are not necessarily drawn to scale. The illustrative embodiments in the following drawings are not meant to be limiting; other embodiments may be utilized and other changes may be made without departing from the spirit or scope of the subject matter presented herein.

FIG. 1 illustrates an interactive wagering system in accordance with at least one embodiment of the presently disclosed invention, the system including at least a game play server and an account server associated with a network.

FIG. 2 is a flow diagram illustrating a method of creating a user account and wagering on the interactive wagering system in accordance with at least one embodiment of the presently disclosed invention.

FIG. 3 illustrates one embodiment of a game selection screen in accordance with at least one embodiment of the presently disclosed invention.

FIG. 4 illustrates one embodiment of a wagering selection screen in accordance with at least one embodiment of the presently disclosed invention.

FIG. 5 illustrates one embodiment of a reward screen in accordance with at least one embodiment of the presently disclosed invention.

FIG. 6 is a flow diagram illustrating a method of wagering on the interactive wagering system in accordance with at least one embodiment of the presently disclosed invention.

### DETAILED DESCRIPTION

In the following description, the present invention is set forth in the context of various alternative embodiments and implementations involving an interactive wagering tool provided to a consumer on either a paper ballot or a network-enabled device that allows consumers to secure a discount for goods and/or services they are currently purchasing, or may purchase in the future, by placing wagers on sporting events either in real-time or prior to the event start. While the following description discloses numerous exemplary embodiments, the scope of the present patent application is not limited to the disclosed embodiments, but also encompasses combinations of the disclosed embodiments, as well as modifications to the disclosed embodiments.

As used herein, the term “sporting event” may include any athletic or non-athletic event publically accessible through television, radio, cable, internet, WAN or LAN networks, live-stream, pay-per-view, or live-attendance. Such events may include sport contests, such as football, baseball, hockey, basketball, tennis, volleyball, golf, swimming, Olympic events, and the like. The athletic events may further include racing events, such as human races and events (e.g., track and field events, marathons, 5K races, etc.), dog races, horse races, automobile races, and the like. The term sporting event may further include non-athletic events, such as eGame events, fantasy sporting events, such as daily sports fantasy, public elections, and the like.

As used herein, the term “predefined outcome” may be taken to refer to any one or more of a final outcome of a sporting event, such as the final score, and significant milestones of the sporting event, such as a score at a relevant time-point during the sporting event (e.g., score at half-time), an action or achievement of a participant in the sporting event (e.g., number of assists for a player, first team to score a goal), a significant event during the sporting event (e.g., over/under, point spread, number of home runs, etc.).

As used herein, the term “target” shall refer to a retail location that may provide goods and/or services, either in a physical location (i.e., brick and mortar store) or a virtual location (e.g., website), or to a specific set, subset, or single unit of merchandise or service(s). Services can be provided by a broad range of industries, such as salon services, transportation services, child care services, cleaning services, etc. The term target may also refer to any hospitality establishment, such as any lodging (e.g., hotel, inn, cabin, camp ground, etc.), entertainment location (e.g., comedy club, theme park, sports event, etc.), and transportation establishment (e.g., bus tour, hot air balloon ride, boat tour, cruise line, train line, etc.).

As used herein, the terms “user”, “consumer”, and “customer” may be used interchangeable, and may be taken to include a person using the methods and system of the present invention.

According to certain aspects, a user of the interactive wagering tool disclosed herein may be referred to interchangeably as a user account. The account-based wagering system disclosed herein may utilize a user account when transacting and performing activities, at the computer level, that are initiated by the user. Therefore, a “user account” represents the user at a computerized level. The user account can perform actions via computerized instructions. For example, according to certain aspects, a user account may be referred to as performing an action, controlling an item, communicating information, etc. Although a user, or person, may be activating a system control or device to perform the action, control the item, communicate the information, etc., the user account, at the computer level, can be associated with the user, and therefore any actions associated with the user can also be associated with the user account. Therefore, for brevity, to avoid having to describe the interconnection between user and user account in every instance, a “user account” may be referred to herein in either context.

Various aspects of the systems and methods may be described and illustrated with reference to one or more exemplary implementations. As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described event or circumstance may or may not occur, and that the description includes instances where the event occurs and instances where it does not. In addition, the word “comprising” as used herein means “including, but not limited to”.

It must also be noted that as used herein and in the appended claims, the singular forms “a”, “an”, and “the” include the plural reference unless the context clearly dictates otherwise. Unless defined otherwise, all technical and scientific terms used herein have the same meanings as commonly understood by one of ordinary skill in the art.

Provided herein are methods for discounting the tariff of a paying customer at a retail establishment, and/or for providing a discount coupon for the future purchase of goods or services. The method may be used to provide customers with a means to select a live event, or an event scheduled to occur in the future, and place a wager on a selected predefined occurrence of the event. Based on the odds of the predefined occurrence, a discount of a monetary value of a current purchase may be secured.

According to certain aspects, based on the odds of the predefined occurrence, and optionally, the monetary value of a customer's future purchase of goods or services, a discount for the future purchase of goods and/or services may be secured, i.e., discount coupon. Exemplary discount coupons include coupons that offer a reduced price (absolute price or discount percentage) for a future tariff at the retail establishment, or for goods and/or services at a different establishment, or for specific goods and/or services that may be purchased at a range of retail establishments.

The predefined occurrence may be an outcome of an event such as a sporting event, or a statistically relevant milestone. The selection of the predefined occurrence and the award of a discount, such as based on successful selection of the predefined occurrence or another preselected factor, i.e. the statistically relevant milestone, may happen in real-time. For example, a customer may select an outcome of an event predicted to occur during a current game and the award may be provided in real-time after that occurrence (i.e., does not have to coincide with the end of the event). The statistically relevant milestone may include a wide range of events, such as a score after the first period of a hockey game, a point spread at half-time of a football game, whether a specific player will have over or under a certain number of points+rebounds+assists, whether the first touchdown to be scored in the game will be a rushing touchdown or a passing touchdown, etc. The selection of the predefined occurrence and the award of a discount, such as based on successful selection of the predefined occurrence or another preselected factor, may be for an event scheduled to occur in the future.

The customer's discount may be determined according to several factors including one or more of: (1) the accuracy of their predicted outcome of certain future events; (2) the amount of their charges at the establishment; (3) other preselected factors determined by a license level within the application; and (4) the number of wagers placed during a given time period. The future events could be a defined occurrence in a sporting event, such as the final score of an athletic contest or a statistically relevant milestone reached by a given participant (e.g. total home runs to date). The other preselected factors can be weighted according to statistical probability or in other manners such as numerical significance (e.g. the total amount of charges to the customer by the retail establishment, total number of lost wagers). The factors and their respective weighting are preselected, at least in part, to construct an incentive for the customer to increase their purchases at the retail establishment.

Thus, according to certain aspects of the presently disclosed invention, the customer may be in control of their potential discount. The customer controls what games of chance (e.g., sporting events) they pick, which means they are ultimately in control of what odds they are selecting or creating (parlay) to determine their discount. They are also in control of how much they spend at the establishment as the more they spend, the higher their discount may be, assuming they pick correctly. Certain other factors, such as number of repeat visits to an establishment, length of each visit, number of successful wagers, number of unsuccessful wagers, etc., may also be included as deciding factors for calculating a discount amount that the user may receive.

The method may be provided to the customer on a network-enabled device, such as a customer's mobile phone, tablet, or personal computer, or an electronic device supplied by a retail establishment.

Thus, provided herein is an interactive wagering tool, i.e. software application, accessible on a network-enabled device such as a mobile device or cell phone, tablet, personal computer, and the like. The wagering tool provides the user with the ability to place wagers on future or live sporting event(s) in a legal manner that may garner discounts, such as discounts of 5%-50% on their tab, or the price of a future tab, or the price of goods and/or services at a specific retail establishment, or the price of a specific good or service at any number of retail establishments, if the user is able to pick an outcome correctly.

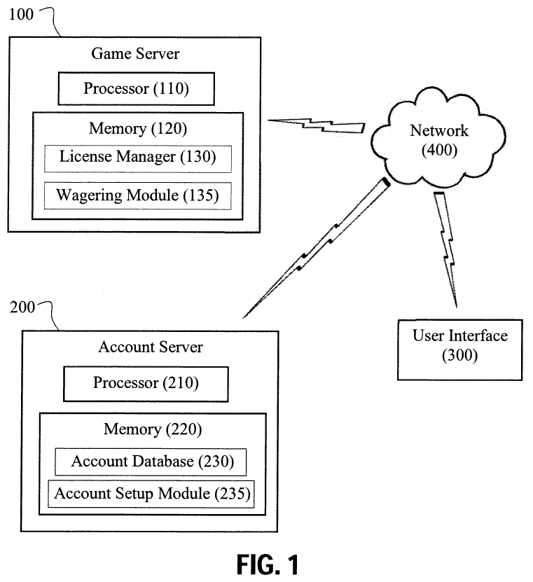

With reference to FIG. 1, the software application may include a game server 100, an account server 200, and a user interface 300, all accessible over a network 400. The software application can be presented over any one or more communications network(s) 400 (e.g., public or private) that provide access to the internet. Exemplary networks include at least wide-area-networks (e.g., WANs, cellular data networks, satellite data networks, fiber-optic networks, and/or other information networks capable of enabling communications over large distances), local-area-networks (e.g., LANs, private gaming networks), file sharing networks, social networks, etc.

Multiple users can be connected to the networks via computing devices, such as mobile phones or tablets, desktop or laptop computers, or any other device capable of communication over one or more data networks. The network 400 may have a variety of configurations, and may comprise wired, wireless or a combination of wired and wireless communication pathways. Depending upon the configuration of the network 400, the network may comprise a wide variety of components. For example, the network 400 may include wireless communication relays or transceivers. The network 400 may also include one or more hubs or routers. The network 400 may include dedicated or public lines. For example, one or more portions of the network 400 may include the Internet, phone lines or the like. In general, the network 400 is simply adapted to permit the transmission of data or information between the game server 100, account server 200, and user interface 300.

The game server 100 can host a website that provides wagering games via the internet (400) and/or other computer networks. The game server 100 can include other devices, servers, mechanisms, etc., that provide functionality (e.g., controls, web pages, applications, etc.) that web users can use to connect to the online wagering website and utilize website features (e.g., communications mechanisms, applications, etc.). The game server 100 can include a memory 120 that may store a wagering module 135 and a license manager 130, and a processor 110 that may execute the computer-executable instructions of at least the wagering module 135.

The account server 200 can store data on a memory 220 for player accounts in an account database 230, and a processor 210 that may execute computer executable instructions that allow a user to create and manage an account, i.e., an account setup module 235.

The user may interact with the game server 100 and the account server 200 via a user interface 300 (i.e., a website) over the network 400. The user interface 300 allows the user to create an account, and select from a variety of wagers and a variety of retailers or merchandise for which they would like to secure a discount. The user does not make any monetary contributions for the wager. As such, there is no downside for the user. The retailer or merchandise distributor offering the discount does so as the presently disclosed interactive wagering tool may provide detailed consumer data from their customers as well as potential new customers in the area (i.e., geographical, demographic, interest). The first person consumer transactional data that may be collected is exceptionally rare and is invaluable to a wide range of companies across multiple industries. Moreover, advertisements such as geo-fenced local advertisements may offer retailers additional incentive to participate and offer discounts through the interactive wagering tool.

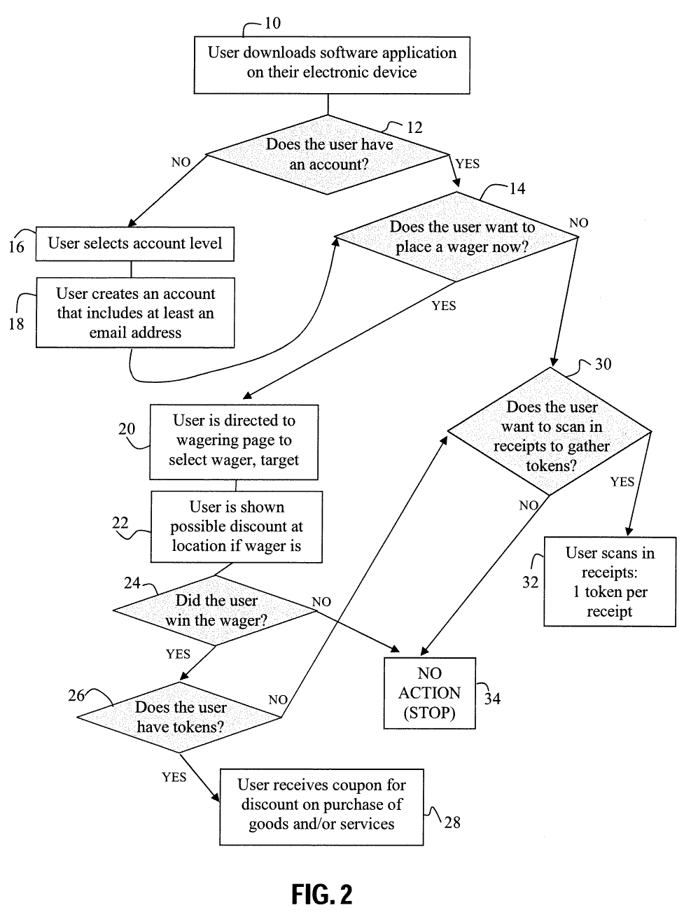

An embodiment of the presently disclosed invention is shown in to FIG. 2. A user of a network-enabled device begins an interaction with the interactive wagering tool by visiting a web page offered by the game server 100 and/or account server 200, or via a software application downloaded to the user's network-enabled device, or a combination thereof. In either case, the user may login to a pre-existing account via the account server 200 or set up a new account if the user has not registered with the account server 200 previously. Account information may be stored in the account database 230 associated with account server 200.

According to certain aspects of the presently disclosed invention, the user interface 300 of the interactive wagering tool may reside on the user's network enabled device. As such, the user may download the user interface 300 to their network-enabled device (step 10). Once the user interface of the interactive wagering tool is downloaded, the user will be queried about their account (12). If they do not yet have an account, they may set up an account that includes at least the user's email address (18). Additional personal information may be gathered at this step, such as the user's location (zip code, city and state, home address, etc.) via either direct input or by location sharing from a location enabled device. The additional personal information may include other demographic information about the user, such as the user's age, gender, etc. Selections of specific user preferences may also be made by the user. These preferences may be used by the interactive wagering tool to suggest or direct a user to specific goods and/or services, and retail establishments, which may be offering promotional discount programs.

Additionally, at the account setup stage, or at any time after they have set up an account, the user may select a pricing tier (16) of the interactive wagering tool that allows the user to elect to receive additional benefits from use of the tool by payment of a monthly fee (see Example IX). Additional user information may be gathered from the user if they elect to participate in paid tiers of the tool (i.e., payment information, home address, etc.). Information about the user selected pricing tier may be stored in the account database 230 of the account server 200. The license manager 130 of the game server 100 may utilize data from the account database 230 to determine the tier level of a user account and allow additional or increased functionality of the user account on the wagering module 135 of the game server 100.

Once the user has downloaded and created an account on the interactive wagering tool, they may login to the tool and elect to place a wager (14). The user may be directed to a wagering page (20) that would provide a variety of possible betting zones related to a predefined occurrence of a sporting event on which they may place a wager. Recall that a predefined occurrence may be an outcome of the sporting event, or a statistically relevant milestone of the sporting event or a participant of the sporting event (e.g., number of goals after the first period, specific action of a specific player, etc.). The user may also be directed to a targets page that provides a variety of possible retailers and/or specific merchandise for which the user desires a discount (i.e., page presenting a plurality of “targets”).

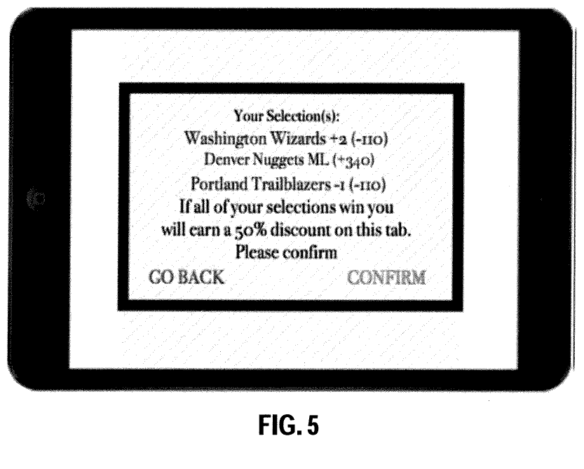

Once the user has selected their wager and target (retailer and/or merchandise or service), they may be shown an expected discount (22) should their wager be successful (24; see also FIG. 5). The systems and methods of the presently disclosed invention may use an inventive mathematical algorithm to determine the user's potential discount percentage based on the odds of their selection(s), which may include parlay variables. When the method is implemented by a software application, such as the interactive wagering tool, the potential discount percentage may be auto-populated on the interactive wagering tool via the user interface 300 before the user locks in their selections.

If the wager is successful, they will receive the discount (28). According to certain aspects of the presently disclosed invention, the system and methods may provide the discount as a coupon. If the user account has an available token (26), they may activate that coupon for use. A “token” is acquired in the presently disclosed interactive wagering tool by scanning into the network enabled device (30) an itemized receipt from any retailer they have available at any time. For each receipt they scan in they will be given one token (32) that may be used for many things inside the interactive wagering tool. For example, the user may use one token to activate their discount (i.e., activate the coupon) for use at the selected retailer or for the selected merchandise or service, or to extend a limited time offer or purchase an offer (see Example IX).

Some consumers may stock pile receipts to gain tokens, such as by scanning in receipts without placing a wager (steps 14 to 30), while others may wait until they are in an establishment, such as a bar or restaurant, win a wager, and use the receipt they currently have open at the bar or restaurant (steps 26 to 30). In this way, they may gain an immediate discount on a current tariff, i.e., activate the coupon using their current receipt as the token to activate the coupon (see Example VII).

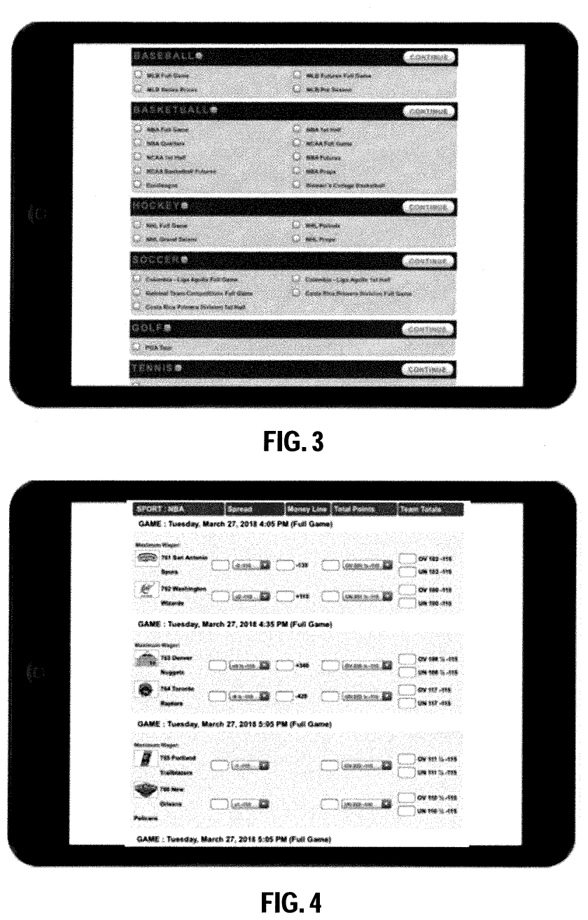

As detailed at step 20 in FIG. 2, the user may pick a desired target from of list of possible targets provided on the interactive wagering tool at which they would like a discount, such as a local bar, and place a wager to receive a discount coupon for a tab currently open. Alternatively, the user may pick any retail establishment at which they would like to receive a discount, or specific merchandise or service for which they would like to receive a discount (both are referred to as targets). They would then select a sports event, and place a wager. That is, the user may be directed to a “betting board” that shows games and contests on which they are able to “wager” (see FIGS. 3 and 4). The user may pick a single game or multiple games (to increase his or her odds). The discount % of the coupon they would win should their picks be correct is auto-populated in real time so that the user may see exactly the % discount of the offered discount coupon (22). This discount % is based on an inventive mathematical formula that uses, in part, the real odds of the sporting events. Once the user makes their selection(s) they will confirm they agree to the discount % being offered and lock in their “wager”.

Should the user lose their wager, nothing would happen (34), i.e., they would not awarded a coupon. Should the user win their wager, their coupon with their agreed upon discount % will appear in their user account on the interactive wagering tool (28). This coupon may be a timed coupon or it may be a permanent coupon. The specific characteristics of the coupon, such as timed or permanent, may be decided by the establishment at which the user would redeem the coupon.

If the user has at least one token in their account on the inventory management tool (26), they would be able to activate their coupon and receive the agreed upon discount. For example, if the user is currently at a bar and has an open tab, they would be able to use a token to activate the coupon and use that coupon on their bill (e.g., show their server to coupon). If they do not have a token available in their account, they may scan an itemized receipt from any retail establishment to gain one token, and use that newly acquired token to activate a coupon. Alternatively, they may request that their tab be closed at the current establishment (e.g., bar or restaurant), or they may request an itemized receipt from the current establishment, and use that receipt to gather a token. According to certain aspects, they could then use that currently activated token to generate a coupon that they could use on the current tab.

As described herein, tokens may be used to activate a coupon so that the user may garner a discount at their selected retailer or for their selected merchandise (i.e., target). The tokens have been described as equal to a scanned itemized receipt from any retail establishment (i.e., 1 token=1 scanned receipt). The number of tokens received for a scanned receipt may be one, as described herein, or may be more than one. According to certain aspects, the interactive wagering tool may offer two or more tokens for scanning certain receipts as a way to incentivize scanning certain receipts, such as to gather information regarding specific retailers or incentivize customers to acquire those receipts (i.e., shop at those retailers). The number of tokens required to activate specific coupons may also vary (i.e., may not be a one to one correlation).

Moreover, while described herein as utilizing scanned receipts, other means for providing tokens are within the scope of the presently disclosed invention. For example, the tokens may be provided when a user signs up for a user account on the interactive wagering tool, or based on the number of wagers placed, or the number of successful wagers placed, etc. Tokens may be provided based on other types of receipts, such as ticket stubs from sporting or music events, etc. Tokens may be provided by retailers for time spent in an establishment or on a retailer's website, or based on a certain amount of money spent at a retailer.

As described herein, coupons may be awarded based on successful wagers. Other means for acquiring coupons are also within the scope of the presently disclosed invention. For example, the interactive wagering tool may award coupons to a user account based on the number of times the user has wagered, the number of successful wagers, a certain number of lost wagers, the number of time a user has wagered for a coupon at a specific retailer or establishment, the number of coupons redeemed at a specific retailer or establishment, etc. These variables may also be influenced by the participating targets (retailer or establishment) and the pricing tier level of the user account.

The interactive wagering tool may be accessible by current customers of a retail establishment, and may be used to improve the customer's experience at the establishment and increases either or both of the time the user spends in the establishment and the likelihood that the user will return to the establishment in the future. The retail establishment may use targeted advertising within the establishment to incentivize use of the interactive wagering tool on the user's network enabled device, or on a device provided by the establishment. The retail establishment may then provide additional rewards for use of the tool within the establishment (e.g., additional free wagers, additional tokens, increased % discount, etc.).

The interactive wagering tool may use geolocation, such as a location provided by a user's network enabled device that indicates the user is within a specific radius of the current establishment (e.g., in the establishment). The interactive wagering tool may also allow input of a code provided by the establishment that would indicate the user is currently within the establishment (e.g., code that changes daily, etc.). Thus, the additional rewards may be garnered when the user is within the establishment. Such services may be used by any retailer or establishment (i.e. code may be provided while at a specific sporting event, or while at a specific service location, e.g., hotel or club).

Alternatively, the retail establishment may provide the customer with a network enabled device that may communicate across a local area network only. Thus, the retail establishment may filter or customize access to the game server and/or account server of the interactive wagering tool. In this manner, a customer that does not own or have a network enabled device with them, or who chooses not to use their own network enabled device, may still participate in the interactive wagering tool. In such cases, account setup may be optional, and may be limited to discounts at the retail establishment providing the network enabled device.

According to certain aspects, the user may be able to create an account, such as an account specific to that retail establishment. For example, the user may use a customized user interface on an electronic device provided by the retail establishment to create an account.

According to various aspects of the presently disclosed systems and methods, any combination of live and future events may be selected by the user, and any combination of real-time and/or future awards of discounts may be provided to the user. A maximum amount of a discount may be set. A minimum amount of a discount may be set based on participation only and not on a favorable outcome of the bet. Discount amounts may be based in part on odds of a specific outcome for a bet, or and outcome for a sporting event (see Table I).

When the discount is offered as a discount coupon, a time limit may be set before the discount expires, such as several hours, days, or weeks. The absolute value or a maximum percentage of the amount of the discount may also be set. According to certain aspects, the amount of the discount may vary as a function of time. For example, the absolute value or percentage discount of the coupon may be reduced the longer the discount coupon is held unused.

When the method is implemented by a software application, the software application may allow the user to create a user profile that may include information about the user (i.e., age, location, gender, etc.). The software application may allow the user to track his/her overall savings by accessing their user profile. As such, the software application may collect customer analytics and information that may be beneficial for each establishment. Moreover, the transactional data within an establishment, and across a number of establishments, may be collected and analyzed. This data may inform on location (geographic and establishment identity), time, and demographics of customers of these establishments. That is, the data will provide information of who is purchasing what and when they are purchasing based on demographics as opposed to just overall total volume within the retail/services/hospitality industry using mystery consumers.

Customer analytics may include customer preferences for certain types or brands of goods and/or services. As such, when a discount coupon is offered, the customer analytics may influence the nature/type of the discount coupon (e.g., salon services, branded sportswear, discounts on certain categories of goods such as food or alcohol, etc. may be included or excluded).

Additionally, the customer analytics may be used to provide a predictive model of consumer's preferences as far as discount percentages. That is, the data provided by the interactive wagering tool and the customer analytics may allow targeting of specific customers based on their betting and redemption trends. For example, the data may predict that 21-25 year olds value any discount between 5-15%, and 35-55 year olds only value coupons 25% or higher. These customer analytics may also allow specific consumers to be targeted based on their betting and redemption trends. For example, if specific consumer redeems 100% of the 20% off or higher coupons but only redeems 40% of coupons below 20%, the interactive wagering tool may provide means to inform retail establishments of higher value offers (i.e., inform establishments that the specific consumer is offered a 20% off timed coupon for free, there is a higher likelihood the consumer will be coming into the establishment).

This never before seen concept and ability for customers to wager a portion of their tab, such as half their tab, or the chance to gain certain discounts on goods and/or services, provides a fun and engaging way for customers to legally enjoy the thrill of sports betting while having a night out. This will surely lead to repeat customers, garner media attention, and more importantly, add perceived value that no wagering system is able to offer. Establishments, i.e., targets, which participate in the systems and methods of the present invention will be more desirable locations, seeing increased foot traffic and/or purchases.

As indicated above, tokens may be used to activate a discount, i.e., activate a coupon for goods and/or services based on a successful wager. According to certain other aspects of the presently disclosed invention, no token may be required to activate a coupon. An exemplary method of the presently disclosed invention in which use of tokens is optional is detailed below. This example is for a consumer using the interactive wagering tool while at a specific retail location. Note, however, that is example should not be taken as limiting of the presently disclosed systems and methods as they may be used on any network enable device while at any location.

1. A customer enters an establishment and is seated/seats themselves as they do in any other establishment. The customer orders food and/or drinks as they would at any other establishment. While generally listed as a restaurant or bar, the retail establishment may be any location at which a customer may purchase a service or product, such as a store, salon, or even an online establishment.

2. Signage as well as up-sell from the establishment staff may be used to educate and guide the customer towards signing up for the presently disclosed interactive wagering system.

3. If the customer does not currently have the software application that runs the interactive wagering system on their network-enabled device, they will begin by downloading the software application, or may use an electronic device provided by the establishment. The customer will then be prompted to sign up to the interactive wagering system, or sign into their previously setup account on the interactive wagering system.

4. For customers who have not yet created an account, they may be prompted to a sign-up page where their information will be collected, such as name, age, gender, phone number, email address, etc. according to certain aspects, additional information may be collected, such as certain retail preferences. They will be able to create an account where they are able to track their rewards/savings. According to certain aspects, no customer account may be needed, such as when the interactive wagering tool is provided on a local area network, i.e., LAN, enabled device provided by the retail establishment (e.g., bar or restaurant at which the user is currently purchasing goods and/or services).

5. Once the customer has signed up and agreed to the terms of service, they may be prompted to select the establishment they are currently in. A manual drop down menu or GPS location may be used to determine this. Alternatively, this may be preselected by the retail establishment, such as when the tool is presented on an electronic device that is network enable only on a LAN of the retail establishment.

6. The customer or server may then be prompted to scan a QR code on the check, or photograph the check.

7. The customer may then be prompted to a “Rules/Instructions” page which details some rules such as how many games they may play, how their discount is calculated, how discounts are applied to their credit, protocol for cash paying customers, and limits on discounts.

8. The customer may be directed to the next page, which will be a “betting board” such as commonly used at online wagering portals. This board may be broken up by sports (Basketball, Football, Baseball, Hockey, etc.). (FIG. 3)

9. After selecting which sport(s) the customer would like to view, they may be directed to a page where they pick their games. Games/events that are occurring that day may show up (i.e., no future events would be listed). Alternatively, games/events that are occurring in the next several days may show up (i.e., future events would be listed). (FIG. 4)

10. Once the customer selects their game(s), they may continue to the next page or section. A pop up screen may come up that is confirming the games they selected as well as the auto generated discount percentage that will be applied to their final bill should their selection(s) be correct, or provided as a coupon. This discount percentage is based on an inventive mathematical algorithm of the present invention. The customer may then confirm their selection(s) and potential discount percentage. (FIG. 5)

11. The customer will be able to track the status of their plays, as well as view their previous tabs/plays and savings earned over the course of their membership via a “My Account” page on the app. The application may update the customer and establishment regarding discounts being added to their tab or “bill” in real-time, and may update the customer and establishment regarding an outcome of the sporting event (e.g., final score or final statistics) once the event is over.

12. According to certain aspects, the interactive wagering tool and the establishment's point of service (POS) system may be integrated. In such a scenario, a transaction identifier of the customer's current transaction may be entered into the system so the establishment's POS will know when a tab needs to be discounted and by what percentage assuming the customer picks the correct plays. Alternatively, the user may obtain a coupon for the disclosed amount useable for a future purchase or goods and/or services.

13. If the consumer's selections (i.e., wagers) are correct and they are awarded a discount coupon, the consumer's tab may be adjusted or they may obtain a coupon for the disclosed discount amount useable for a future purchase or goods and/or services.

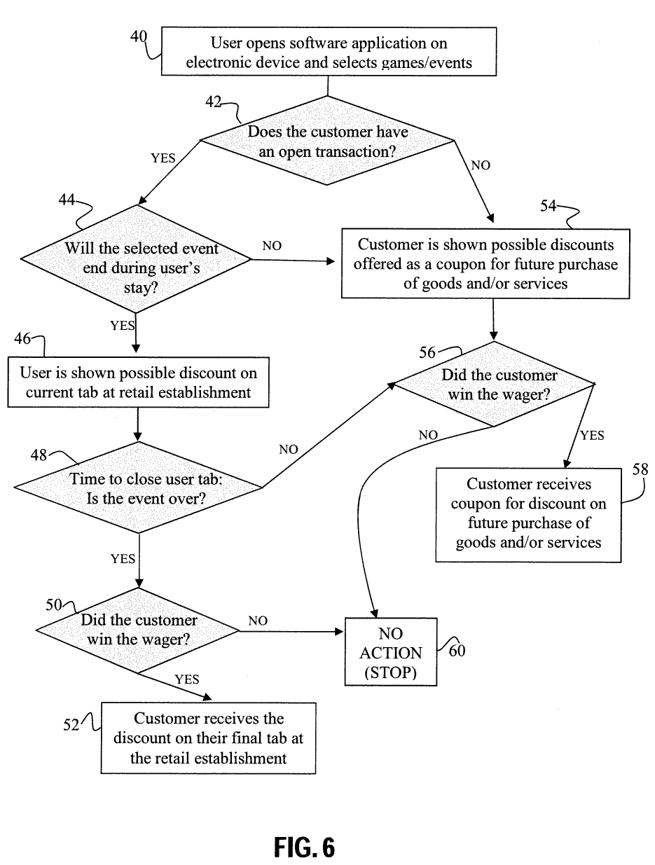

With reference to FIG. 6, a customer may open the software application and select a game or event on which to place a wager (40) while at home or at a retail establishment. If the customer is at a retail establishment, and has an open or pending transaction (42), they may be able to select an event that will occur during their stay at that retail establishment (44), and will be shown possible discounts on the tariff they may garner based on a successful wager (46).

If the customer stays for the duration of the selected game or event (44), and they have won the wager (50), they may receive a discount on their current tab (52) presented as a coupon on the presently disclosed interactive wagering tool. They may use that coupon for their current tab. If the customer decides to leave the retail establishment before the game or event is over (44), they may use the discount coupon on a future purchase at that retail establishment or a different retail establishment (54). This may be based on customer selections when placing the wager, or on selections offered by the retail establishment. If the customers wager is successful at that later time (56), they may receive a coupon good for the goods/service they have selected (58).

As shown in step 42, if the customer does not have an open transaction, such as when they are using the software application while at home, they may be shown possible discounts offered as a coupon usable on future purchases (54).

According to certain aspects of the presently disclosed invention, the methods disclosed herein may be implemented by a software application to run on a network-enabled device so that a customer (user) may secure a discount for goods and/or services that the customer is purchasing by choosing to participate in the above process.

As disclosed hereinabove, according to embodiments that use tokens, the systems and methods may further comprise receiving a scan of at least one retail receipt and associating the scanned receipt with a user account, wherein each scanned receipt is assigned one token. Further, the systems and methods may comprise determining if the user account has at least one token associated therewith, and if the user account does have at least one token, associate a successful outcome for the wager with a coupon for the predicted discount amount usable at the selected target. The associated coupon may then be activated (i.e., use the token to activate the coupon).

Note, while the presently disclosed invention has thus far described the methods and systems as using one token to activate one coupon, according to certain aspects, certain coupons may require no tokens for activation, or may require more than one token for activation.

The application may inform the customer as to the factors (odds, amount of customer bill, etc.), the manner in which they are weighted, and other information that is relevant to determining the amount of the discount. The application then passes to a field of chance opportunities (e.g. a field of sporting event that are concurrent with the time that the customer is in the retail establishment). The customer then selects their predicted outcomes from the field of available choices. At this point, the application informs the customer as to the value of their discount in the event that the customer has accurately predicted some or all of the possible outcomes from their selected field of choices.

As the sporting event or other chance opportunity progresses, the application may update the customer, and optionally the retail establishment, according to developments of the event relative to the customer's predictions.

As indicated, the presently disclosed methods may be implemented by a software application configured to be executed as an interactive wagering tool (i.e., software application) on a network-enabled device. Certain of the data collected by the software application may be sent to a server and/or storage device that is separate from servers, memory, storage devices of the user's network-enabled device. This data may be stored and analyzed, and may be accessed by the individual users, i.e., participating customers who have created user accounts and may access information regarding their accounts and use of the system. This data may be stored and analyzed, and may be accessed by the retail establishment, i.e., participating retail establishments who may use the data to track demographic and other sales information.

Storage device(s) (e.g., nonvolatile storage) may include ROM, flash memory, a hard drive, or any other suitable optical, magnetic, or solid-state storage medium, or a combination thereof. The storage device(s) may store data (e.g., data corresponding to customer identity, a customer transaction, etc.), instructions (e.g., software or firmware for the interactive wagering tool), and any other suitable data. In addition, a variety of settings and parameters associated with customer data and/or customer selections may be stored in the storage device(s) and/or memory device(s), along with computer code configured to provide a specific output during operation of the application.

The programs and systems of the interactive wagering application of the present invention may be configured to work across many platforms (e.g., Android, iOS, Microsoft Windows, UNIX, etc.). Moreover, the presently disclosed software applications may use programming of one or both of the graphics processing unit (e.g., CUDA, DirectX or OpenCL) and the central processing unit to enhance the computational performance

The programs and systems of the interactive wagering application of the present invention may include location data that may be used to provide geo-fenced information or notifications. A geo-fence is a virtual boundary of a geographical area. The geo-fenced notifications may include a textual notification and/or other data, such as a Uniform Resource Link (URL) to a web page. For example, the notification may include an advertisement or coupon, or may be a personalized message such as targeted advertising, or a reminder left by the user to be presented upon reentering the geo-fence.

The programs and systems of the interactive wagering application of the present invention may be configured to display on a display of the network enabled device information related to a specific target (e.g., retailer or merchant). The interactive wagering tool may generate a push notification, such as when the user is approaching a designated target location. The push notification, which can be displayed by the network enable device even if the interactive wagering tool is not open at that time, can include, for example, the name of the target, the address/location of the target, the distance from the user to the designated target location, etc.

Implementations of the interactive wagering application are described within the context of a device configured to perform various steps, methods, and/or functionality in accordance with aspects of the described subject matter. It is to be appreciated that the interactive wagering tool of the presently disclosed invention can be implemented by one or more computing devices. Implementations of the interactive wagering tool can be described in the context of a “device configured to”, wherein the term configured may be taken to mean that the device can implement computer-executable instructions that are executed to perform various steps, methods, and/or functionality in accordance with aspects of the described subject matter.

In general, a computer system or computing device can include one or more processors and storage devices (e.g., memory and disk drives) as well as various input devices, output devices, communication interfaces, and/or other types of devices. A computer system or computing device can also include a combination of hardware and software. It should be appreciated that various types of computer-readable storage media can be part of a computer system or computing device.

As used herein, the terms “memory”, “computer-readable storage media” and “computer-readable storage medium” do not mean and unequivocally exclude a propagated signal, a modulated data signal, a carrier wave, or any other type of transitory computer-readable medium. In various implementations, the wagering application may include a processor configured to execute computer-executable instructions and a computer-readable storage medium (e.g., memory and/or additional hardware storage) storing computer-executable instructions configured to perform various steps, methods, and/or functionality in accordance with aspects of the described subject matter.

Computer-executable instructions can be embodied and/or implemented in various ways such as by a computer program (e.g., client program and/or server program), a software application (e.g., client application and/or server application), software code, application code, source code, executable files, executable components, routines, application programming interfaces (APIs), functions, methods, objects, properties, data structures, data types, and/or the like. Computer-executable instructions can be stored on one or more computer-readable storage media and can be executed by one or more processors, computing devices, and/or computer systems to perform particular tasks or implement particular data types in accordance with aspects of the described subject matter.

The inventive software application disclosed herein can implement and utilize one or more program modules. Generally, program modules include routines, programs, objects, components, data structures, etc., that perform particular tasks or implement particular abstract data types.

The software application disclosed herein can be implemented as a distributed computing system or environment in which components are located on different computing devices that are connected to each other through network (e.g., wired and/or wireless) and/or other forms of direct and/or indirect connections. In such distributed computing systems or environments, tasks can be performed by one or more remote processing devices, or within a cloud of one or more devices, that are linked through one or more communications networks. In a distributed computing environment, program modules can be located in both local and remote computer storage media including media storage devices. Still further, the aforementioned instructions can be implemented, in part or in whole, as hardware logic circuits, which can include a processor.

The software application disclosed herein can be implemented by one or more computing devices such as computers, PCs, server computers configured to provide various types of services and/or data stores in accordance with aspects of the described subject matter. Exemplary sever computers can include, without limitation: web servers, front end servers, application servers, database servers, domain controllers, domain name servers, directory servers, and/or other suitable computers.

Certain examples are provided herein as exemplary of the presently disclosed invention. None of these examples should be considered limiting of the scope or functionality of the presently disclosed inventive methods or systems.

The following aspects are disclosed in this application:

Aspect 1. A method for discounting a tariff by interaction with an interactive wagering tool, the method comprising: presenting a plurality of betting zones on the output interface of the network enabled device, wherein each of the plurality of betting zones is related to a predefined occurrence; and receiving from the input interface of the network enabled device a wager, wherein the wager comprises a selection of at least one of the plurality of betting zones.

Aspect 2. The method according to aspect 1, further comprising: presenting a plurality of targets on an output interface of a network enabled device, wherein each of the plurality of targets is related to a consumer opportunity; and receiving from an input interface of the network enabled device a selection of one of the plurality of targets.

Aspect 3. The method according to aspect 2, further comprising: calculating a predicted discount amount useable at the target based on a favorable outcome of the at least one betting zone.

Aspect 4. The method according to aspect 3, further comprising, presenting the predicted discount amount on the output interface of the network enabled device.

Aspect 5: The method according to any one of aspects 1 to 4, further comprising: associating the wager with a user account.

Aspect 6: The method according to any one of aspects 1 to 4, further comprising: associating a successful outcome for the wager with a coupon for the predicted discount amount usable at the selected target, wherein the coupon is associated with a user account.

Aspect 7: The method according to aspect 6, further comprising: presenting the coupon on the output interface of the network enabled device.

Aspect 8: The method according to any one of aspects 1 to 7, further comprising: receiving a scan of at least one retail receipt and associate the scanned receipt with a user account, wherein each scanned receipt is assigned one token.

Aspect 9: The method according to aspect 8, further comprising: determining if the user account has at least one token associated therewith, and if the user account does have at least one token, associating a successful outcome for the wager with a coupon for the predicted discount amount usable at the selected target.

Aspect 10: The method according to aspect 8 or 9, wherein the scan is received from one or more of a camera, a magnetic reader, an optical scanner, a radio-frequency detector, and a near-field communication sensor.

Aspect 11. The method according to any one of aspects 2 to 10, wherein the target comprises a retail establishment, a service, goods, or any combination thereof.

Aspect 12. The method according to any one of aspects 1 to 11, wherein tile predefined occurrence relates to a predicted outcome of a sporting event.

Aspect 13. A wagering system comprising: a non-transitory memory comprising processor-executable instructions; and a processor coupled to the non-transitory memory and configured to execute the processor-executable instructions, wherein the processor-executable instructions comprise instructions to execute the method according to any one of aspects 1 to 12.

Aspect 14. The system according to aspect 14, further comprising: a network interface for receiving information about the plurality of betting zones, wherein the plurality of betting zones relate to at least one predefined outcome of a sporting event; a network interface for communicating with a plurality of network enabled devices; a database for storing account information related to one or more users of the network-enabled devices.

Aspect 15. One or more tangible machine-readable storage media having instructions stored thereon, which when executed by a set of one or more processors causes the set of one or more processors to perform operations according to any one of aspects 1 to 12.

### EXAMPLES

### Example I

### Exemplary Discounts

Table I includes exemplary discounts that may be provided as a discount coupon based on a predefined occurrence (i.e., spread on a game). Thus, if the user plays a 3-team parlay, 3 games at −110=+600 odds=40% discount (14.3% chance of hitting); or 3 games at (+110)+(+120)+(+150)=+1,050 odds=50% discount (8.7% of hitting).

TABLE I

| Odds | % Discount |
|---|---|
| +1,000 or above | 50 |
| +615 to +999 | 45 |
| +425 to +614 | 40 |
| +424 to +315 | 35 |
| +314 to +245 | 30 |
| +244 to +195 | 25 |
| +194 to +155 | 20 |
| +154 to +125 | 15 |
| +124 to −110 | 10 |
| Even or below | 5 |

### Example II

### Example for Bar/Restaurant with Wager on a Current Game/Event

A customer eating lunch at a bar at 1 pm places a wager for a baseball game that is about to start or which has only recently started. The customer picks the home team for a 10% discount. This discount percentage is based on an inventive mathematical algorithm of the present invention. The home team wins later that afternoon, while the customer is still at the bar (i.e., before the customer's tab has been closed out). When the customer's bill is tallied, e.g., the tab is closed out, the 10% discount will be applied. If the customer wagered using an account on the software application, information on the day's activity may be stored/updated in the customer's account.

### Example III

### Example for Bar/Restaurant with Wager on a Future Game/Event

A customer eating lunch at a bar at 1 pm places a wager for a baseball game at 7:05 pm. He picks the home team for a 10% discount and the home team wins later that evening. This discount percentage is based on an inventive mathematical algorithm of the present invention. The customer will be given a digital coupon on the software application (i.e., interactive wagering application) for the future purchase of goods and/or services, such as the future purchase of a meal at the bar. According to certain aspects, the digital coupon may be non-transferrable (e.g., from the software application) and may have a specific time limit for use. As such, the customer will have a time-frame in which he needs to use the coupon, such as 24 hours, 48 hours, or one week, or even 30 days. According to certain aspects, the retail establishment may set parameters (discount amounts, time limits, etc.) for the digital coupons. The digital coupon will incentivize the customer to return to the retail establishment to gain their discount.

In a similar fashion, the software application may incentivize the customer to go to a retail establishment. For example, a customer may be debating on going to the bar to watch the Monday night football game. The customer can locate the local bar on the software application from home, and place a bet on a team playing in the football game. If the selected team is up 38-3 at halftime, for example, the customer may know that a discount on services at the local bar has been secured once the game ends. For example, if the selected team wins, the customer may secure a 10% off coupon on a meal that night. Now, the consumer is incentivized to go into the establishment and watch the 2nd half of the game because he knows he can eat and drink for 10% off that night.

### Example IV

### The Interactive Wagering Application in Retail Sectors

According to certain aspects, a user of the interactive wagering application may be able to obtain discount coupons for goods and/or services from a wide variety of retail establishments. For example, the user may want to bet on an outcome of the Monday Night Football game, but would like to use a successful outcome of that bet to gain a discount on sporting gear rather than a discount of food or drinks at a bar or restaurant. The user may access the interactive wagering application to view which retailers are participating, and may pick a retailer offering the goods in which they are interested (e.g., such as “DICK'S Sporting Goods”, “Dunhams Sporting Goods”, or “Footlocker”). Selection may be from a menu offered on the interactive wagering application, such as on a drop down menu. The user would then continue use of the interactive wagering application as normal by picking an event and an outcome, agreeing to a discount percentage (which is based at least on the odds), and confirming the wager within the application.

If the selected team wins/outcome occurs for that selection, the user may receive a discount coupon (i.e., the discount coupon would be added to the user's account). All portions of the transaction may be accesses through the interactive wagering application (e.g., there is no need to directly access the website of the retail establishment selected). According to certain aspects, the digital coupon may be non-transferrable, and may have a time limit for use. As such, the rewarded consumer will have a timeframe in which to use the coupon. This essentially allows the consumers create their own “black Friday hysteria” by garnering limited time offers and increasing impulse buys by getting them into the store to spend their coupon. Since the consumer has selected the retail establishment at which they wish to secure their discount, the interactive wagering application will also provide important and informative data regarding consumer preferences, etc.

If the user loses the wager, nothing happens.

In this day and age, many applications such as Postmates, Uber Eats, DoorDash, GrubHub, etc and even Amazon Prime offer expedited shipping options or a means to stay home. These services are essentially incentivizing the consumer to stay at home. The ability of the present invention to issue flash sale coupons in real-time will incentivize consumers to physically go into the establishments and make purchases. Moreover, the interactive wagering tool gives the power back to the consumer by allowing them to create their own coupons in real time, thus incentivizing them to go into retail establishments. The alternative is waiting for a coupon or discount % offered by the establishment that they may or may not like or even use.

### Example V

### Interactive Wagering Tool Discount Coupons

Current discount programs for specific products may place the product on sale, such as by offering a promotional discount at the local grocery store. Every time the specific product is sold from that store, it is discounted by the promotional amount at the register via a coupon. At the end of the month, the product distributor offering the promotional discount is given a bill for how many items are sold, multiplied by the promotional discount amount, and the distributor reimburses the grocery store.

The presently disclosed software application will provide a means to offer discounts on specific brands of items, and not just discount coupons good a specific retail establishments. Thus, instead of us being limited to just targeting retailers like a DICK's sporting goods or a Wal-Mart, the presently disclosed software application will provide a means to target specific brands. For instance, let's say a discount for Under Armour is desired, the brand can allocate a certain budget for the promotional discount program, such as to a marketing initiative on the inventive software application. The software application will provide discount coupons to the consumer which may be scanned at the register of a number of, or all of, the retail establishments that sell Under Armour. Once the budget amount of the promotional discount program has been reached, the discount coupon code will no longer be offered.

As discussed above, and according to certain aspects, the present software application will be able to provide companies with analytics on just how often people are trying to wager for specific items (so they can gauge popularity of this program). Moreover, it will incentivize the consumers to not only purchase the items of a specific company, but it will also drive foot traffic into the stores that offer these items, which will garner more impulse buys while they are in there because of the expiration of the coupon. The presently disclosed systems and methods may also allow the target to “up-sell” the customer, instead of simply putting items in a cart and getting them shipped to them. This up-selling by a target also applies to the hospitality industry, such as a bar and restaurant industry, where increased discounts may be offered to customers who are currently in an establishment.

### Example VI

### Exemplary Predefined Outcomes

Beyond selecting the final score of a sporting event, or the winning team, there are many other events or actions in a sporting event on which a user may wager. Below are provided a few exemplary actions that can be wagered on in various sporting events. Note, this list is provided as exemplary of the types of actions that may be wagered on, and is not exhaustive. Many other actions are possible and within the scope of the presently disclosed invention.

Football

Quarter TD's. An option may become available before the start of a quarter, such as at the end of a previous quarter, or at specific times within a quarter allowing a user to wager on a score during that quarter. For example, the user may bet on how many touchdowns, field goals, etc., will be scored in the quarter.

Drive. An option may become available as soon as it is official that a drive will begin, and again at each point when it becomes official that there will be a new set of downs. These option(s) may close when the drive terminates (i.e., when the outcome of the drive is known). The wagering choices may include: (1) Turnover; (2) Punt; (3) Missed Field Goal; (4) Field Goal; (5) Touchdown; and (6) Clock expires. For example, if the driving team punts and the other team fumbles the punt, then the drive is over, ending in a punt, and a new drive begins Also, safeties and missed fourth down attempts may be considered to be turnovers.

Next Score. An option may become available at the beginning of the game, at the beginning of the second half, and after each drive ends. The user may be allowed to place wagers on (1) Team 1 touchdown; (2) Team 2 touchdown; (3) Team 1 field goal; (4) Team 2 field goal; (5) Team 1 safety; (6) Team 2 safety; (7) No more scoring; etc.

Baseball—Baseball is similar to football in the sense that the action is broken up into easily identifiable pieces. Examples of bettable events in baseball include batter's turn at bat, inning, winner, next score, winning pitcher, losing pitcher, winning margin, and number of home runs.

Batter. The user may wager on the outcome of each batter's turn at bat. For example, the user may wager on an out due to a strike out, fly out, or ground out; or a successful at bat due to a successful bunt, a single, double, triple, or home run.

Inning. The user way wager on the outcome of the inning or half inning. Some basic choices on which a user may wager include no runs; one run; two runs; etc.

Tennis—Examples of wagering events include winner of game, winner of set, and winner of match. For example, the user may wager on who will win each game, final score of each game, etc. The user may wager on who will win each set. The user may wager on who will win each match.

Basketball, Hockey, Soccer—Sports like basketball, hockey and soccer do not have as many natural break points. Nevertheless, a user may wager in events such as the next scoring team, the next scoring player, a lead change, a quarter or period scoring, a high scorer, a high rebounder, a next foul or penalty (either team or player), a point spread, an over-under, etc.

Racing—It is interesting to consider how new technology can change an old pastime. Typically, all betting on horse races is done prior to the beginning of the race. However, if the crowd at a horse race has Internet access, they can wager based on a current race. The same would hold true for dog racing, auto racing, and even for human races and events. Wagering can include those that are placed before the start of the race, such as: win, place, and show. The wagering choices for each event may be the list of participants in the race (horse, dog, etc.). Additionally, the user may be able to place a wager at set time periods during the race. The odds may change during the race, so that the user that guessed correctly early in the race will have an advantage.

### Example VII

### Exemplary User Interaction with the Interactive Wagering Tool

As an example, a user may have selected to wager for a discount at a local bar. If the user has successfully wagered, a coupon with their agreed upon discount % will appear in the interactive wagering tool.

(a)—If the user is in the establishment and has at least one token in their account and would like to settle their tab, they simply activate their coupon by using a token and receive the agreed upon discount on their bill by simply showing their server. At any time, the user may scan in any receipt they have from any previous transaction, whether with a target (i.e., retailer offering discounts on the interactive wagering tool), or non-target (i.e., retailer not currently offering discounts on the interactive wagering tool), to receive a token. These tokens may be used to activate a coupon.

(b)—If the user is in the establishment and does not have any token in their account, they would request the final bill, scan it in, be given a token in their account. They could then use that token to activate their coupon and receive the agreed upon discount on their bill by simply showing their server.

(c)—If the user is not in the establishment, but has at least one token, they will simply need to go into the establishment before their coupon expires, open a bill, activate their coupon with a token and receive their discount off their bill by simply showing their server.

(d)—If the user is not in the establishment, and does not have at least one token, they will simply need to go into the establishment before their coupon expires, open a bill, scan in that bill to receive a token, activate their coupon with the token and receive their discount off their bill by simply showing their server.

### Example VIII

### Daily Sport Fantasy

Fantasy sports games include contests that allow a participant to act as the owner/manager of a fantasy sports team and to select one or more real-life players whose success or lack thereof in real sporting events determines the success of the participant. Several variations applicable to team sports involve a participant building a fantasy team that includes one or more real life players. The fantasy team competes against other fantasy teams based on statistics generated by the real individual players or teams of a professional, or in some case a collegiate or other amateur, sport. According to certain aspects, variables such as salary caps, point caps, etc. may be placed on the team selection.

The sporting events of the presently disclosed invention may include online or live fantasy sports games or events. For example, the interactive wagering tool may include a sporting event that includes multiple lineups a day in one or more sports set by a professional (e.g., in-house or online) daily fantasy guru. Users of the interactive wagering tool would be able to create their own lineups to go against the lineups presented by the interactive wagering tool (e.g., as setup by the professional sports guru, and if the user is able to beat the lineup of the interactive wagering tool, the user would win the wager (i.e., win the agreed upon discount coupon).

### Example IX

### Payment Tiers

A user of the presently disclosed interactive wagering tool may use the software application for free, i.e., without payment of a monthly fee, or may opt to increase the functionality and rewards provided by the interactive wagering tool by paying a monthly fee associated with a specific “tier” of the software application. Provided below in Table II are three exemplary tiers, wherein a first tier may be accessed for free a second tier may require a minimal first fee, and a third tier may require a second fee that is higher than the first fee.

TABLE II

| | TIER | | |
|---|---|---|---|
| | I | II | III |
| Cost | Free | $1.99/month | $2.99/month |
| Discounts | 5% to 25% | 5% to 35% | 5% to 50% |
| Wagers per month | 10 | unlimited | unlimited |
| Ability to purchase offers with tokens | Yes | Yes | Yes |
| Access to establishment leaderboards | No | Yes | Yes |
| Access to special promotions | No | Yes | Yes¹ |
| Ability to leave/view reviews of retailers | No | Yes | Yes |
| Number of wagers at one time | One | Multiple | Multiple |
| Wagers at multiple locations | No | No | Yes |
| Extend limited time offers | No | No | Yes² |
| Coupon after 5 plays in a month | 5% | 15%³ | 20%³ |
| Coupon after 10 plays in a month | 10% | 20%³ | 25%³ |

¹Additional special promotions offered in Tier III;
²Extend offers using tokens;
³After 5 losses or 10 losses.

While specific embodiments of the invention have been described in detail, it should be appreciated by those skilled in the art that various modifications and alternations and applications could be developed in light of the overall teachings of the disclosure. Accordingly, the particular arrangements, systems, apparatuses, and methods disclosed are meant to be illustrative only and not limiting as to the scope of the invention.

What is claimed is:

1. A wagering system comprising:
a non-transitory memory comprising processor-executable instructions; and
a processor coupled to the non-transitory memory and configured to execute the processor-executable instructions, wherein the processor-executable instructions comprise instructions to:
present a plurality of targets on an output interface of a network enabled device, wherein each of the plurality of targets is related to a consumer opportunity;
receive from an input interface of the network enabled device a selection of one of the plurality of targets;
present a plurality of betting zones on the output interface of the network: enabled device, wherein each of the plurality of betting zones is related to a predefined occurrence;
receive from the input interface of the network enabled device a wager, wherein the wager comprises a selection of at least one of the plurality of betting zones;
calculate a predicted discount amount useable at the target based on a favorable outcome of the at least one betting zone; and
present the predicted discount amount on the output interface of the network enabled device.

2. The wagering system of claim 1, wherein the processor-executable instructions further comprise instructions to:
associate the wager with a user account.

3. The wagering system of claim 1, wherein the processor-executable instructions further comprise instructions to:
associate a successful outcome for the wager with a coupon for the predicted discount amount usable at the selected target, wherein the coupon is associated with a user account.

4. The wagering system of claim 3, wherein the processor-executable instructions further comprise instructions to:
present the coupon on the output interface of the network enabled device.

5. The wagering system of claim 1, wherein the processor-executable instructions further comprise instructions to:
receive a scan of at least one retail receipt and associate the scanned receipt with a user account, wherein each scanned receipt is assigned one token.

6. The wagering system of claim 5, wherein the processor-executable instructions further comprise instructions to:
determine if the user account has at least one token associated therewith, and if the user account does have at least one token, associate a successful outcome for the wager with a coupon for the predicted discount amount usable at the selected target.

7. The wagering system of claim 5, wherein the scan is received from one or more of a camera, a magnetic reader, an optical scanner, a radio-frequency detector, and a near-field communication sensor.

8. The wagering system of claim 1, wherein the target comprises a retail establishment, a service, goods, or any combination thereof.

9. The wagering system of claim 1, further comprising:
a network interface for receiving information about the plurality of betting zones, wherein the plurality of betting zones relate to at least one predefined outcome of a sporting event;
a network interface for communicating with a plurality of network enabled devices;
a database for storing account information related to one or more users of the network-enabled devices.

10. The wagering system of claim 1, wherein the predefined occurrence relates to a predicted outcome of a sporting event.

11. One or more tangible machine-readable storage media having instructions stored thereon, which when executed by a set of one or more processors causes the set of one or more processors to perform operations comprising:
presenting a plurality of targets on an output interface of a network enabled device, wherein each of the plurality of targets is related to a consumer opportunity;
receiving from an input interface of the network enabled device a selection of one of the plurality of targets;
presenting a plurality of betting zones on the output interface of the network enabled device, wherein each of the plurality of betting zones is related to a predefined occurrence;
receiving from the input interface of the network enabled device a wager, wherein the wager comprises a selection of at least one of the plurality of betting zones;
calculating a predicted discount amount useable at the target based on a favorable outcome of the at least one betting zone; and
presenting the predicted discount amount on the output interface of the network enabled device.

12. The one or more tangible machine-readable storage media of claim 11, wherein the operations further comprise:
associating a successful outcome for the wager with a coupon for the predicted discount amount usable at the selected target, wherein the coupon is associated with a user account.

13. The one or more tangible machine-readable storage media of claim 11, wherein the operations further comprise:
presenting the coupon on the output interface of the network enabled device.

14. The one or more tangible machine-readable storage media of claim 11, wherein the operations further comprise:
receiving a scan of at least one retail receipt and associating the scanned receipt with a user account, wherein each scanned receipt is assigned one token.

15. The one or more tangible machine-readable storage media of claim 14, wherein the operations further comprise:
determining if the user account has at least one token associated therewith, and if the user account does have at least one token, associating a successful outcome for the wager with a coupon :for the predicted discount amount usable at the selected target.

16. A method for discounting a tariff by interaction with an interactive wagering tool, the method comprising:
presenting a plurality of targets on an output interface of a network enabled device, wherein each of the plurality of targets is related to a consumer opportunity;
receiving from an input interface of the network enabled device a selection of one of the plurality of targets;
presenting a plurality of betting zones on the output interface of the network enabled device, wherein each of the plurality of betting zones is related to a predefined occurrence;
receiving from the input interface of the network enabled device a wager, wherein the wager comprises a selection of at least one of the plurality of betting zones;
calculating a predicted discount amount useable at the target based on a favorable outcome of the at least one betting zone; and
presenting the predicted discount amount on the output interface of the network enabled device.

17. The method of claim 11, further comprising:
associating a successful outcome for the wager with a coupon for the predicted discount amount usable at the selected target, wherein the coupon is associated with a user account.

18. The method of claim 12, further comprising:
presenting the coupon on the output interface of the network enabled device.

19. The method of claim 11, further comprising:
receiving a scan of at least one retail receipt and associating the scanned receipt with a user account, wherein each scanned receipt is assigned one token.

20. The method of claim 14, further comprising:
determining if the user account has at least one token associated therewith, and if the user account does have at least one token, associating a successful outcome for the wager with a coupon for the predicted discount amount usable at the selected target.
